(19) United States
(12) Patent Application Publication
(10) Pub. No.: US 2011/0185809 A1
(43) Pub. Date: Aug. 4, 2011

(54) UNIVERSAL FLASH SYSTEM AND APPARATUS FOR PETROLEUM RESERVOIR FLUIDS STUDY

(76) Inventors: Paul Guieze, Fontenailles (FR); Darcy Ryan, Edmonton (CA); Anil Singh, Rosharon, TX (US); Brian Abbott, Edmonton (CA)

(21) Appl. No.: 13/059,661

(22) PCT Filed: Aug. 21, 2009
(86) PCT No.: PCT/EP2009/006233

§ 371 Date: Apr. 26, 2011

Related U.S. Application Data
(60) Provisional application No. 61/091,279, filed on Aug. 22, 2008.

(51) Int. Cl. G01N 9/00; E21B 47/10; G01N 30/02; G01N 11/00

(52) U.S. Cl. 73/32 R; 73/152.18; 73/23.35; 73/61.52; 73/54.01

(57) ABSTRACT

A flash system and method is disclosed to control the rate of flashing a reservoir fluid sample from reservoir conditions to a given pressure and temperature in order to produce a liquid and a gas phase of the sample. The flash system comprises a flash apparatus including a separating chamber, a metering valve positioned at an inlet of the separating chamber, and a gas flow meter positioned at an outlet of the separating chamber. A pump is provided to displace the sample from a sample chamber to the flash apparatus, wherein the pump speed and the discharge rate of the metering valve can be automatically controlled. The flash system may be used in a laboratory environment and at the site of an oilfield reservoir. The present disclosure provides a universal flash system and method that can limit operator actions to a minimum of simple operations to ensure the repeatability of the process independent of the operator's skill.

### CROSS-REFERENCE TO RELATED APPLICATION

The present application is based on and claims priority to U.S. Provisional Application No. 61/091,279, filed Aug. 22, 2008.

### TECHNICAL FIELD

The present disclosure relates generally to flash separation of a fluid sample and, more particularly, to flash separation of a reservoir fluid sample from reservoir conditions to standard atmospheric conditions.

### BACKGROUND ART

Reservoir fluid samples collected downhole and transported to surface, or collected at surface, are commonly tested to determine various properties useful for optimizing the exploration and production of the well. Prior to performing certain tests, the reservoir sample is maintained or re-conditioned to initial reservoir conditions, which are well above atmospheric conditions. However, other analytical techniques require the reservoir fluid samples to be at atmospheric conditions prior to being introduced into particular analysis equipment, such as gas chromatographs, liquid chromatographs, densitometers, viscometers, calorimeters and the like.

Flash experiments are commonly used in the oil and gas industry to convert a reservoir fluid sample from reservoir conditions to atmospheric conditions. More particularly, flash experiments are commonly used to produce a liquid and a gas phase from a single phase sample by expanding the conditioned single phase sample from a high pressure and high temperature to a lower pressure multiphase sample. Flash separation of a conditioned reservoir sample (a “live sample”) requires a significant amount of skill and care as it will condition the accuracy and significance of the reservoir fluid composition. The main result of a flash experiment is the gas-to-liquid molar ratio, generally reported as GOR (Gas Oil Ratio), which is a volumetric form.

Additional properties are also measured during a flash experiment, such as oil shrinkage factor (for oil samples), gas expansion factor (for gas samples), density, viscosity of the liquid phase, identification of the sample constituents, etc.

During a typical flash experiment, the live sample is maintained at reservoir conditions on one side (upstream), while the other side (downstream) is preferably at atmospheric pressure and either ambient temperature or any other required temperature. The flash experiment can also apply to any live sample taken at surface, such as at the well head, a multiphase meter, or a test separator.

A flash experiment should ideally be maintained at a true thermodynamic equilibrium, but in practice is not always close to this ideal state. The equilibrium is achieved if full mass transfer occurs, which means that the two-phase contact time has been long enough and that the contact area has been large enough.

Currently, most flash experiments are performed in oilfield fluid analysis laboratories, and sometimes performed directly at the well site during well site Pressure-Volume-Temperature (PVT) analysis (for example, using a SCHLUMBERGER well site PVT system, such as PVT EXPRESS or PVT XP), or are part of specific wellsite tools (for example, the SCHLUMBERGER PHASESAMPLER). A control system and a method for the operation of a flash separation apparatus are described, for example, in US 2006/219633 A1.

Flash apparatus can be divided in two distinct categories: dynamic flash systems and static equilibrium systems.

The dynamic equilibrium method consists of maintaining the pressure (e.g., reservoir pressure) upstream the metering, or cracking, valve while maintaining atmospheric conditions downstream the metering valve. This type of dynamic flash apparatus can be found in most oilfield analysis labs, as well as in all oilfield equipment where a flash experiment is needed in the field. Generally, in a dynamic flash system, the pump that drives the single phase sample and the metering valve operation are manually operated, which induces variability related to the geometry of the apparatus as well as the operator's skill. This feature makes the dynamic flash experiment very sensitive to the process speed. The accuracy of the experiment generally relates to the operator's skill, who must “feel” the metering (or cracking) valve for cracking the pressure and be extremely careful in all measurements to not discharge the valve at too high of a rate. In practice, there is a tendency for the operator to proceed too fast in operating the metering valve, or pump, resulting in inadequate mass transfer and erroneous readings. Mistakes in the “feel” of the metering valve can lead to liquid carry-over, and thus inaccuracy of the gas-to-liquid molar ratio (the GOR), along with inaccuracies of other measurements.

Dynamic flash apparatus typically do not have a gas circulation system, and therefore the gas does not stay in contact with the liquid for a sufficient amount of time for the equilibrium to be complete. However, it was demonstrated, and will be described in detail herein, that a good design of a dynamic flash apparatus which allows a better contact (i.e., increased residence time and increased contact area) between gas and liquid associated with a very slow metering process can provide data close to ideal.

The static flash experiment, which is generally used in the laboratory, consists of flashing the full sample from reservoir conditions to atmospheric conditions, then circulating the gas phase though the liquid phase until the thermodynamic equilibrium is complete. This technique is generally accepted as being more reproducible since it does not depend on the operator's skill or experiment conditions (speed, etc.). However, static flash systems require more sophisticated and bulky apparatus, which significantly increases cost and requires a larger footprint that makes it difficult to use at the well site. Laboratory flash apparatus typically include a circulating system that forces gas to bubble through the liquid until the full thermodynamic equilibrium is achieved.

Therefore, a need exists to provide a flash system that minimizes operator error, while producing accurate and reproducible results. It is an aim of the present disclosure to provide a substantially automated universal flash system and method that may be used at or near the well site to achieve high accuracy measurements while limiting the operator action to a minimum of simple operations, such as preparation of the equipment, single shot measurements, etc.

### SUMMARY OF INVENTION

In a first aspect, the present disclosure relates to a flash system adapted to control the rate of flashing a reservoir fluid sample from reservoir conditions to a given pressure and temperature in order to produce a liquid and a gas phase of the sample, the flash system comprising a flash apparatus including a separating chamber, a metering valve positioned at an inlet of the separating chamber, and a gas flow meter positioned at an outlet of the separating chamber; a pump adapted to displace the sample from a sample chamber to the flash apparatus, and means for automatically controlling the metering valve and the pump to control the pump speed and the discharge rate of the metering valve.

In a preferred embodiment of the first aspect, the metering valve comprises an outlet tube that drives the sample to the bottom of the separating chamber.

In another preferred embodiment of the first aspect, the gas flow meter measures the flow rate of the gas leaving the separating chamber, and the measured flow rate of the gas can be used in controlling the pump speed and the discharge rate of the metering valve.

In another preferred embodiment of the first aspect, the separating chamber further comprises means for measuring the volume of liquid in the separating chamber.

In another preferred embodiment of the first aspect, the flash system further comprises a gas chromatograph to measure physical properties of the gas exiting the flash apparatus, and a gas storage bag to store the gas leaving the flash apparatus. In yet another preferred embodiment of the first aspect, the flash system further comprises a liquid chromatograph to measure physical properties of the liquid exiting the metering valve of the flash apparatus.

In another preferred embodiment of the first aspect, the flash system further comprises a sample chamber for storing the sample. The sample chamber may include a floating piston for applying a desired pressure to the sample.

In another preferred embodiment of the first aspect, the means for automatically controlling the metering valve and the pump comprise a microprocessor, or a plurality of sensors in a closed-loop control system.

In another preferred embodiment of the first aspect, the given pressure and given temperature are atmospheric pressure and standard temperature, respectively.

In another preferred embodiment of the first aspect, the system further comprises a liquid storage chamber for safely storing the liquid separated in the flash apparatus.

In a second aspect, the present disclosure relates to a method to control the rate of flashing a reservoir fluid sample from reservoir conditions to a given pressure and temperature in order to produce a liquid and gas phase of the sample, the method comprising the steps of displacing the sample from a sample chamber to a flash apparatus using a pump, the flash apparatus comprising a separating chamber, a metering valve positioned at an inlet of the separating chamber, and a gas flow meter positioned at an outlet of the separating chamber; and flash separating the sample in the separating chamber to generate a gas and a liquid phase, wherein the metering valve and the pump are controlled by a microprocessor to ensure full control of the pump speed and a low discharge rate of the metering valve.

In a preferred embodiment of the second aspect, the method may further include the step of analyzing the separated gas and liquid phase using a gas chromatograph or liquid chromatograph, respectfully.

In another preferred embodiment of the second aspect, the method may further include the steps of measuring the mass, density or viscosity of the liquid in the separating chamber.

Other aspects, characteristics, and advantages of the present disclosure will be apparent from the following detailed description.

### BRIEF DESCRIPTION OF THE DRAWING

Various aspects and embodiments of the invention are described below in the appended drawings to assist those of ordinary skill in the relevant art in making and using the subject matter hereof. In reference to the appended drawings, which are not intended to be drawn to scale, like reference numerals are intended to refer to identical or similar elements. For purposes of clarity, not every component may be labeled in every drawing.

FIG. 1 depicts a schematic view of a flash system according to embodiments disclosed herein.

FIGS. 2A-2E depicts a schematic illustration of a method of flashing according to embodiments disclosed herein.

FIG. 3A-3G depicts a schematic illustration of an alternative method of flashing according to embodiments disclosed herein.

FIG. 4 depicts a schematic view of an alternative flash system according to embodiments disclosed herein.

### DETAILED DESCRIPTION

The direct flash experiment consists essentially of changing a reservoir fluid sample from initial reservoir conditions (which have preferably been conditioned to a single phase) to atmospheric conditions (liquid and gas phases produced from the single phase sample). The initial conditions (single phase) should be maintained prior to flashing the reservoir fluid sample to ensure a proper displaced volume measurement. The final conditions, however, are preferably controlled and maintained at or near a constant level after flashing the reservoir sample, wherein the pressure is preferably maintained at atmospheric conditions, and the temperature can be controlled in any manner that resists changes during the experiment due to various environmental reasons.

To establish a complete thermodynamic equilibrium at the final stage of the flash experiment, some operating conditions should be carefully controlled, and the system design preferably includes the following considerations:
the gas-liquid contact should be as large as possible;
the residence time of the gas phase should be as long as possible;
the rate of the flashing should be as low as possible;
upstream pressure and temperature should remain constant; and
downstream pressure and temperature should remain constant.

Automation of certain key steps of the flash experiment, such as controlling the metering valve, helps to ensure repeatability of the process independent of the operator's skill, and also ensures full control of the sample displacement and pressure throughout the system.

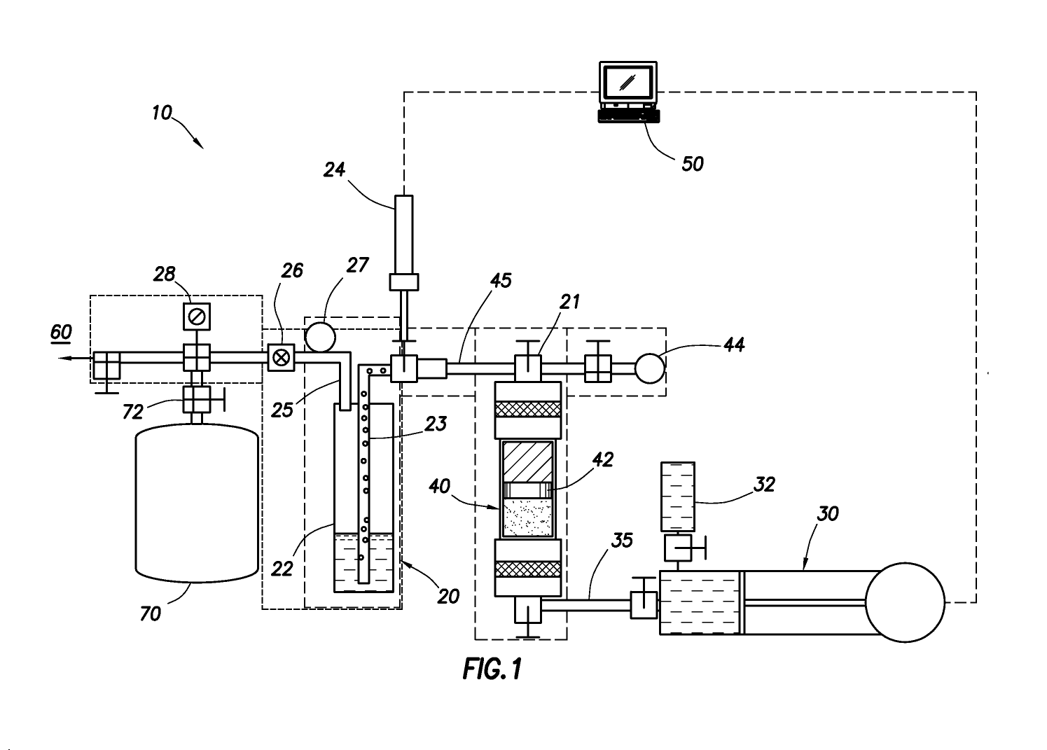

Referring now to FIG. 1, a schematic view of a flash system 10 according to embodiments disclosed herein is shown. The flash system 10 of the present disclosure is adapted to flash a reservoir fluid sample that has preferably been conditioned to a single liquid phase (the “live sample”) from reservoir conditions to atmospheric pressure and a given temperature in order to produce both a liquid and a gas phase of the sample (the “flashed sample”). The flash system 10 is shown to comprise a flash apparatus 20 having a separating chamber, or separator, 22 and a metering valve 24, a pump 30 for displacing the live sample from a sample chamber 40 to the flash apparatus 20 and for maintaining reservoir-type conditions in the sample chamber 40, and means for automatically controlling the metering valve 24 and the pump 30 to ensure full control of the pump speed and the discharge rate of the metering valve 24.

The flash apparatus 20, or universal flash apparatus (UFA), according to the present disclosure is designed to generate atmospheric gas and liquid phases at atmospheric pressure and any given temperature. In an exemplary implementation of the flash apparatus 20, the gas is driven to the bottom of a separating chamber 22, thus allowing the gas to bubble through the liquid phase prior to going to a gas vent line 25. Driving the flashed sample from the outlet of the metering valve to the bottom of the separating chamber helps to ensure a good contact between the gas and liquid phase, as this process also agitates the liquid phase thereby breaking up the gas bubbles and creating a larger contact area for equilibrium to occur, which speeds up the diffusion of components. Where the gas is driven to the bottom of the separating chamber 22 and leaves the separating chamber 22 at the top, the gas follows the longest possible path in the flash apparatus 20. Increased contact between the gas and liquid phase also helps to achieve thermodynamic equilibrium.

The live sample to be flashed to atmospheric conditions is initially stored in the sample chamber 40 and ideally comprises only a single phase (liquid), but more realistically comprises multiple phases (gas trapped in a liquid). Prior to being stored in the sample chamber 40, the live sample has preferably been conditioned to remove any water from the fluid sample, leaving only oil.

The sample chamber 40 is preferably equipped with a floating piston 42 or any other type of device (e.g., a membrane) for applying a desired pressure on the live sample. In a preferred implementation, the floating piston 42 also acts to separate the live sample from a hydraulic fluid, the pressure and volume of which can be directly controlled by the pump 30 in combination with a hydraulic fluid tank 32 connected by a series of hydraulic fluid lines 35 and valves. Moreover, the pressure of the sample chamber 40 may be controlled by a pressure transducer 44 in communication with the sample line 45. The sample chamber 40 is preferably constructed from corrosion resistant stainless steel, titanium, or any other material capable of withstanding the conditions required by the live sample. The sample chamber 40 need not be a specific component of the system 10, but may be any type of sample chamber used in other systems to capture and transport reservoir fluids. In a preferred implementation of the present embodiment, the sample chamber 40 is heated to a predetermined reservoir temperature, such as one-hundred and fifty (150) degrees Celsius, and maintained at the predetermined temperature by means of a temperature control arrangement, such as a heating mantle, heating jackets, heating elements, or the like. It should be understood, however, that the sample chamber 40 may be maintained at any temperature or pressure necessary for the purpose of the experiment.

The pump 30 in fluid communication with the sample chamber 40 for displacing the live sample from the sample chamber 40 to the flash apparatus 20 and for maintaining reservoir or other conditions in the sample chamber 40 is preferably automatically controlled by a microprocessor 50 or the like to ensure smooth operation. The pump, or automatic pump, 30 may be any type of pump, such as a positive displacement pump capable of delivering fluid at a steady, low flow rate, preferably without surging, such as but not limited to a twin head high pressure liquid chromatography pump. The automatic pump 30 may be of any type capable of displacing fluid and exerting a required pressure. A preferred embodiment of the pump 30 of the present disclosure consistently and repeatedly displaces a defined volume of fluid at a defined pressure, thereby ensuring that a desired rate of fluid flow is accurately provided by the pump 30.

Leading from the sample chamber 40 into the flash apparatus 20 is a sample line 45 which preferably functions to transmit the displaced live sample from the sample chamber 40 to the metering valve 24. The sample line 45 to the flash apparatus 20 is preferably a flexible tubing, such as but not limited to thin metal or plastic conduits, where the contents in transit can be heated and maintained at the same temperature as the live sample stored in the sample chamber 40. Controlling the temperature of the live sample transmitted through the sample line 45 is important to avoid any cold points, which can cause fluctuation in the flow rate and inaccurate experiment results. The flow of the live sample through the sample line 45 is controlled by a plurality of valves, such as a course valve 21 and the metering valve 24, each of which will be explained in more detail hereinafter.

In a preferred embodiment, the flash apparatus 20 comprises the separating chamber 22, the metering valve 24, a gas flow meter 26 and miscellaneous fittings, valves, sensors, gauges (i.e. pressure and temperature) and flow lines inside an enclosure where the temperature can be controlled thereby ensuring a good thermodynamic equilibrium. The means for controlling the temperature of the enclosure containing certain components of the flash apparatus 20 includes such cooling and heating means known in the art to maintain any temperature between around zero (0) degrees Celsius to around sixty (60) degrees Celsius, as an example, however the preferred temperature likely depends on the fluid characteristics and type of the reservoir fluid sample (i.e., heavy oil to lean gas). The ideal temperature of the enclosure should be the standard temperature (for example, 15.56° Celsius), which avoids further conversions which are not accounted for in the difference of equilibrium between standard and ambient temperature; wherein, standard temperature is most likely below ambient temperature, thereby preventing any condensation of heavy components between the flash apparatus and the GC analyzer. The means for controlling the pressure of the flash apparatus 20 may include a pressure transducer 27 connected to the microprocessor 50, in combination with either a piston-type cylinder in communication with the separating chamber 22, or a gas bag 70, which will be explained in more detail hereinafter.

The metering valve 24, also referred to herein as a cracking valve, includes an inlet and an outlet, and is preferably motor-driven (i.e., a servo-motor controlled fine metering needle valve) for a precise control of the sample rate. The motor-driven operation of the metering valve 24 is preferably optimized for low to ultra-low flow rates. The metering valve 24 is preferably adapted to open/close at a few microns per second, or a few nanometers per second. The metering valve 24 may be a linear sliding type needle valve adapted for operation at high temperatures and pressures, including a Teflon® coating or the like. The metering valve 24 is preferably controlled by the microprocessor 50 in order to achieve a smooth, low flow rate, but may be directly controlled by a plurality of sensors in a closed-loop control system.

The pump 30, the metering valve 24, and pressure in either the separating chamber 22 and/or sample chamber are preferably controlled by a microprocessor-type controller 50, such as adapted for a personal computer, for ensuring a smooth operation, which complies with substantially constant conditions both upstream and downstream the metering valve 24. In an alternative embodiment, however, each of these components may be controlled by a sensor or plurality of sensors in a closed-loop system where minimal or no “processing” is required.

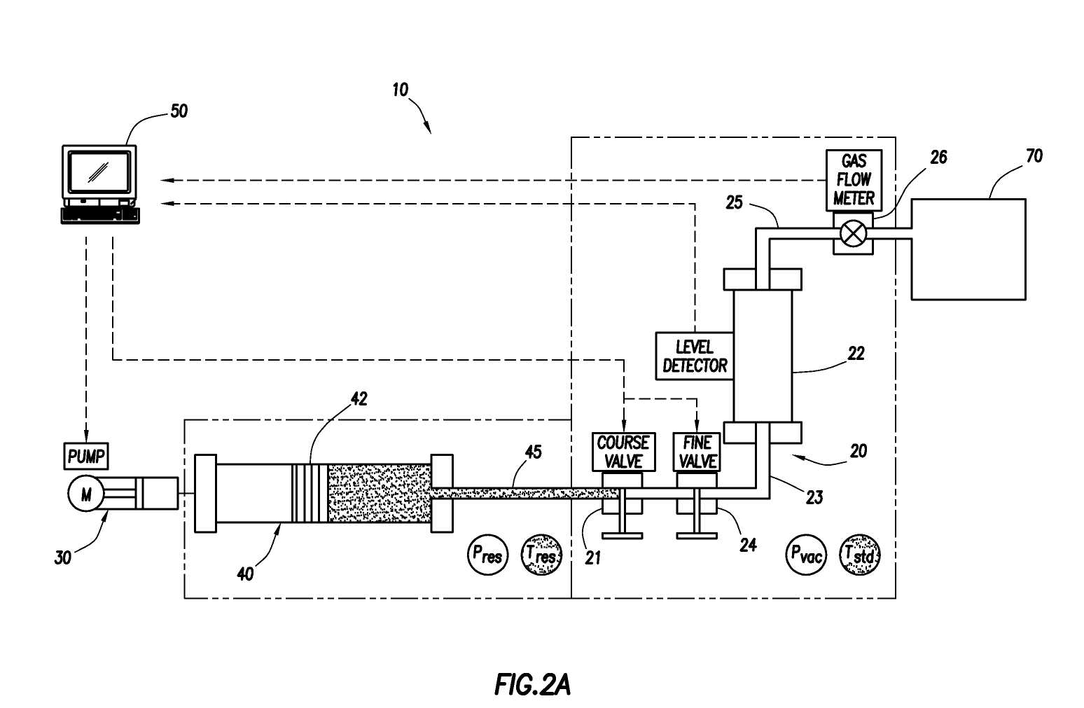

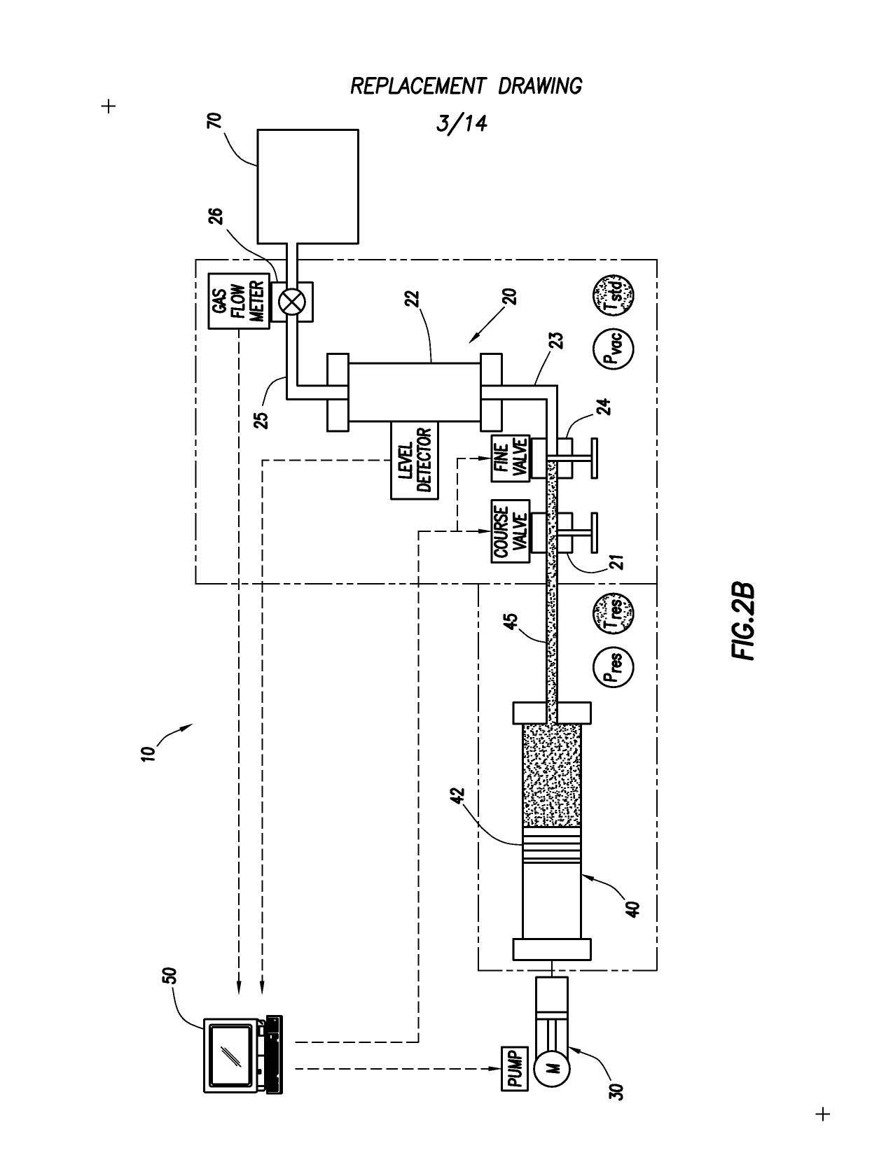

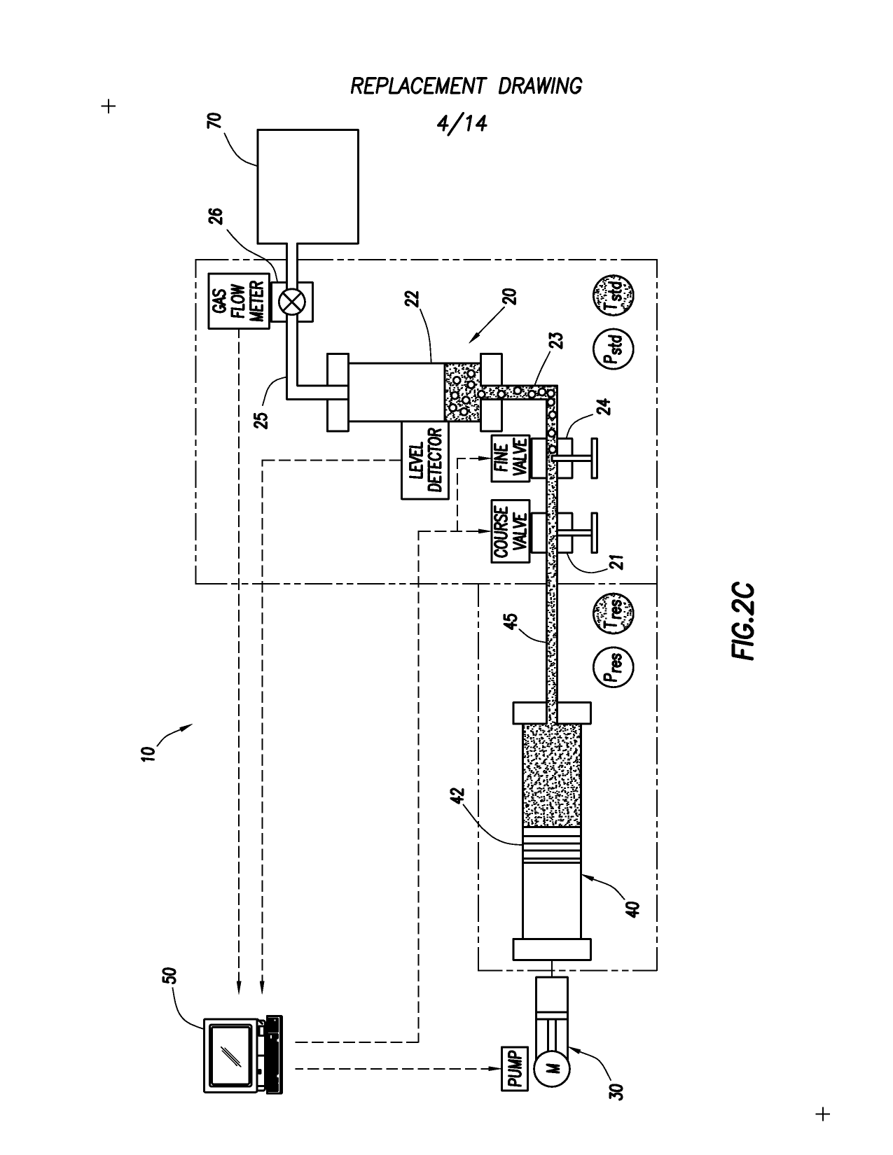

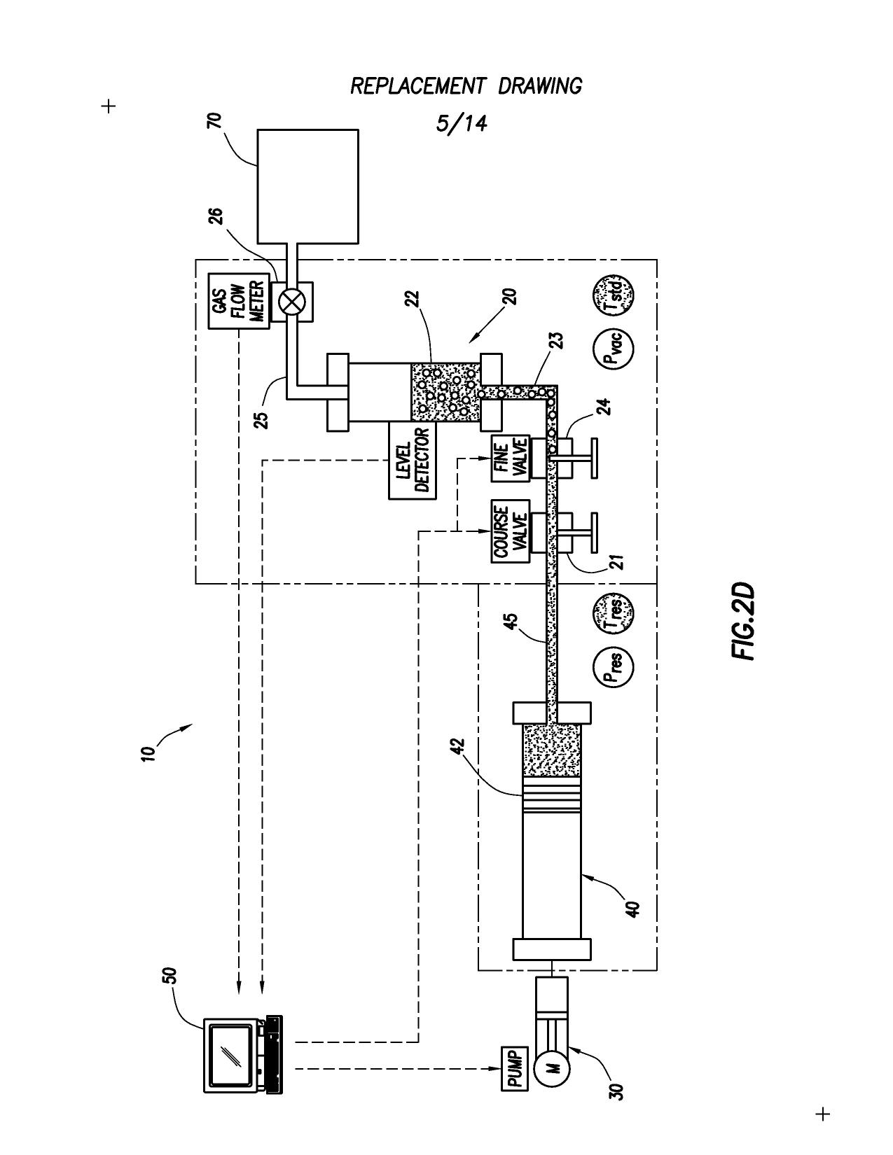

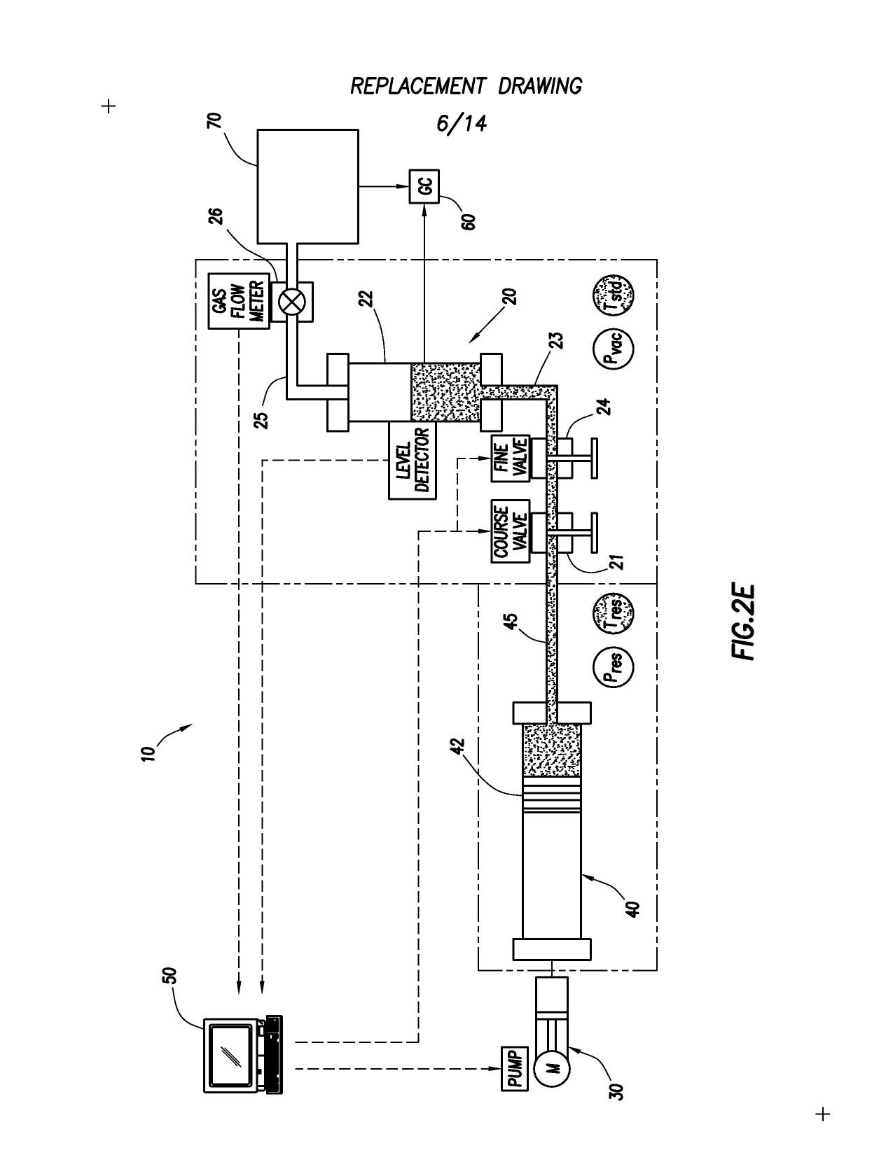

In a preferred operation, the metering valve 24 is opened at a predetermined ramp rate to initiate flow of the live sample. The ramp rate will primarily depend on the reservoir fluid type. In this embodiment it is assumed that the metering valve 24 has two functions: a primary function for opening and closing the flow; and a secondary function for metering or regulating the flow rate. Once flow of a gas phase of the flashed sample is detected at the gas flow meter 26, the microprocessor 50 will change modes from the primary mode to the secondary, metering mode in order to control the pump 30 and the metering valve 24 to maintain flow of the gas and liquid at a desired rate. The microprocessor 50 may receive feedback from the downstream pressure transducer 27 representative of the pressure in the separating chamber 22, and subsequently send a signal to the means for controlling the downstream pressure in order to maintain or adjust the pressure to atmospheric or another desired level. Normal high pressure valves with rotating or non-rotating stems will have an inherent dead band that arises due to initial friction in unseating and seating the valve from the shut-off position. Prolonged use of the valve can degrade the seat and this dead band which can become difficult to characterize. Linear sliding metering valves using high force capacity actuator, for example Piezoelectric stacks, overcome this to a large extent, but will require large actuation forces to overcome the load induced by high pressure on the valve stem, especially if it requires to perform shut-off and metering. This high actuation force may lead to actuator sizes that are bulky. To overcome this, the two main functions may be separated by using two valves in series, shown further in FIGS. 2A-2E, one primarily to perform the shut-off and course control and the other to perform fine control metering. The course control valve 21 may be a normal high pressure valve and the fine control valve 24 can be a linear sliding type valve with a stem that travels in the micron range. Moreover, the microprocessor 50 preferably monitors and sends actuation signals to the temperature control arrangement representative of a desired temperature for both the upstream and downstream temperature.

The portion of the sample line 45 exiting the metering valve 24 and entering the separating chamber 22 is referred to herein as the outlet tube 23. The outlet tube 23 preferably extends from the metering valve 24 to the bottom of the separating chamber 22, and drives the flashed sample to the bottom of the separating chamber 22 allowing the evolving gas flowing through the segregated liquid, thus ensuring a good contact between oil and gas while generating agitation, which facilitates the diffusion of components.

The separating chamber 22, in combination with the metering valve 24, primarily functions to separate and temporarily store the gas and liquid phases of the flashed sample at atmospheric conditions. The separating chamber 22 preferably includes a liquid trap portion for temporarily, and safely, storing the segregated liquid phase of the flashed sample. The separating chamber 22 is preferably made of a material chemically inert to natural petroleum analytes (i.e, hydrocarbons, H₂S, CO₂, etc.). The separating chamber 22 may further include the pressure transducer 27, as described above, that controls the pressure during the flash, preferably to ensure that such pressure is close to atmospheric. In a further embodiment, the pressure transducer 27 may be connected to the microprocessor controller 50. The separating chamber 22 may include a plurality of other sensors for fluid property measurements, either in communication with the microprocessor 50 or not.

Moreover, safe handling of liquid samples maintained at sub-ambient temperature equilibrium is more difficult as volatile components could evaporate. There is a need to keep a low temperature when handling such liquid samples in containers that can potentially be opened to the atmosphere. The temperature control of the system 10 allows any temperature to be selected according to the best method for retaining the initial mass, and ensuring accurate measurements. Atmospheric liquid samples are preferably maintained at a temperature lower than the temperature inside the thermal enclosure to avoid any light component loss due to evaporation.

The gas leaving the separating chamber 22 preferably enters a gas vent line 25 leading to the gas flow meter 26 and a switching valve 28, explained in more detail hereinafter, for either direct injection into a gas chromatograph (GC) 60 or a gas storage bag 70.

In a preferred embodiment of the present disclosure, the gas flow meter 26 of the flash apparatus 20 is adapted to measure any gas leaving the separating chamber 22, by way of volume or mass, at any given flash conditions (i.e., atmospheric or other pressure, and a predetermined downstream temperature). The gas flow meter 26 is preferably connected to the microprocessor 50 to provide a signal representative of the gas flow rate that can be used by the microprocessor 50 in controlling the metering valve 24 or the pump 30. One advantage of the gas flow metering and sampling is the minimization of the size of the temperature controlled volume while enabling a larger dynamic range of measurements relative to conventional floating piston gas meters. The gas flow meter 26 may be of a positive displacement type, a cumulative flow rate type or any flow meter type (i.e., mini-coriolis, thermal, transport, or the like) capable of accurately measuring low flow rates of gas. In the case of thermal-type flow meters, an additional device, such as a mini-calorimeter may be placed downstream of the flow meter so that an accurate estimation of the heat capacity, which can be used to derive an accurate correction factor for the flow meter.

The switching valve 28 positioned in the gas vent line 25 is preferably adapted to provide direct injection into a gas chromatograph 60 or a gas storage bag 70. The dedicated line to the gas chromatograph (GC) 60 preferably comprises heating means to heat the line to a temperature slightly higher than the temperature maintained in the enclosure of the flash apparatus 20 in order to avoid any heavy component condensation, which could bias the molecular composition to be measured. The gas composition analyzed by the GC 60 can be performed several times during the experiment by fast gas chromatography for both verifying the constant process and calculating the gas physical properties that could be needed for the gas flow meter conversion to volume (e.g., density, specific heat, etc.). As the produced gas is subsequently analyzed by the GC 60, any physical property, such as, density, specific heat, and the like needed for converting the signal to volume is available from simple calculations, and may be provided to the microprocessor 50 used for controlling the pump 30 and the metering valve 24. Monitoring the gas composition ensures a quality control of the flash process stability while giving access to physical properties needed for the conversion of flow meter signal to volume if needed.

Gas leaving the separation chamber 22 may also be collected into the gas storage bag, or gas bag 70 placed outside of the temperature controlled enclosure, preferably having a larger capacity than the maximum expected produced volume. Controlling access to the gas bag 70 may be a shutoff valve 72 in combination with the switching valve 28. The gas bag 70 is made of suitable material, which should be inert to natural components of hydrocarbons. In a preferred embodiment, the gas bag 70 provides two important functions: (1) collect the evolved gas exiting the flash apparatus 20; and (2) maintaining atmospheric pressure in the downstream volume. The gas bag 70 preferably does not add any significant differential pressure while collecting the gas. The gas collected in the gas bag 70 may be further analyzed or disposed in an environmental safe manner. It should be understood, however, that alternative means for maintaining atmospheric pressure in the downstream volume may be employed, such as a pump, piston-cylinder, or the like, which may be controlled by the pressure transducer 27 and microprocessor 50. It should also be understood, that the gas bag 70 may be replaced by another receptacle, such as a laboratory-type cylinder.

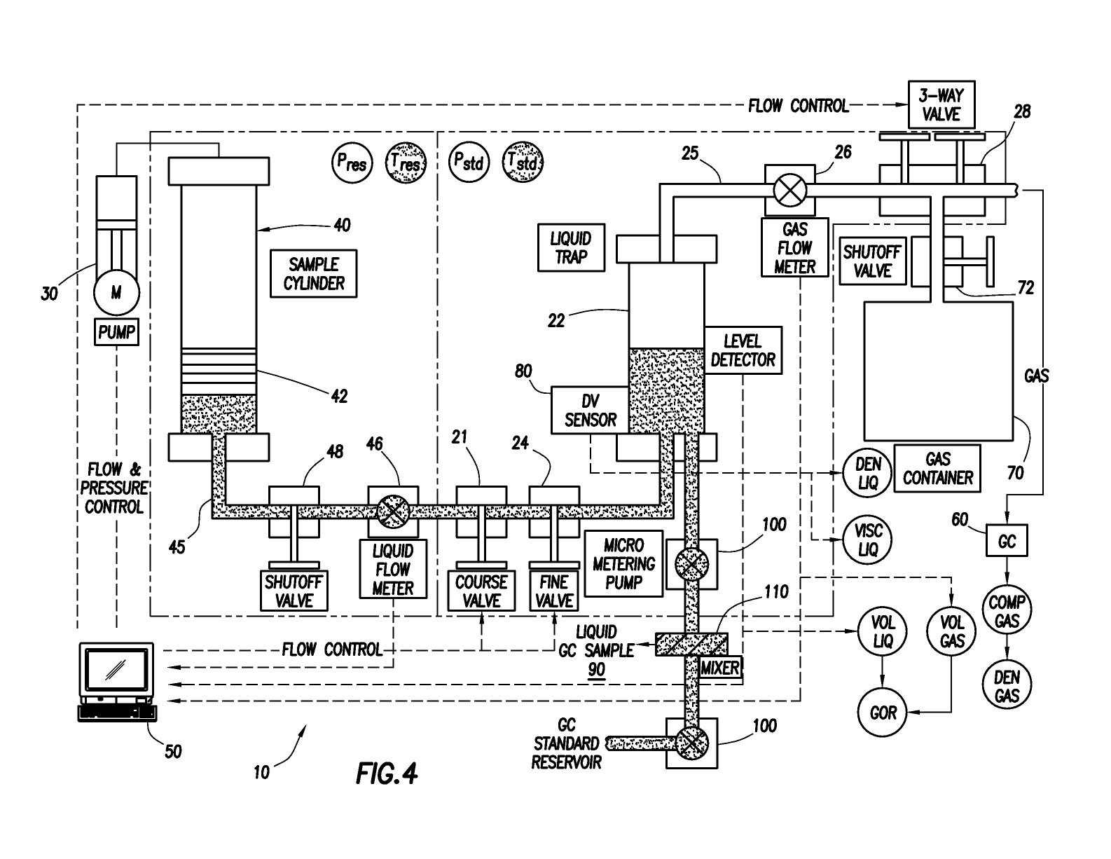

The liquid volumes can accurately be obtained from mass and density measurements of the liquid contained in the separating chamber 22, or liquid trap. Measuring mass of the liquid in the liquid trap is far more accurate than direct volume measurements of the liquid, and allows a better accuracy for small quantities, which also extends the range of the gas-to-liquid ratios that the flash apparatus 20 can handle. The mass measurement is typically manually performed due to the complexity of automation. Additional measurements such as liquid density measurements can be measured manually using state of the art equipment such as a vibrating tube apparatus using a small volume of the liquid. Alternatively the system 10 can be modified to include a density viscosity type sensor 80, as shown in FIG. 4. Examples of density viscosity type sensors 80 may include, but are not limited to a SCHLUMBERGER EXCALIBUR density viscosity sensor. The density viscosity sensor 80 can be connected to the microprocessor 50 and can be configured to directly read the liquid density and viscosity without the need for any additional instrumentation or automation of the process. With such a device, a means of measuring the liquid height may be employed in the device, using an optic, ultrasonic or other sensor, and with a calibrated liquid trap of a specified geometry, the volume of liquid can be calculated directly and accurately.

Also shown in FIG. 4, the flash system 10 may comprise a liquid chromatograph 90 for measuring the composition of the liquid portion of the flashed sample. Such liquid chromatograph 90 may include a micro-metering pump 100 to dispense a known volume (i.e., in micro liters or smaller) of the liquid. The sample of the flashed liquid portion may be mixed, in a mixer 110 or the like, with a known liquid, displaced by another micro-metering pump 100, to improve interpretation of the liquid chromatograph 90, as is standard practice in chromatography laboratories. The liquid chromatograph 90, the micro-metering pump 100, and the mixer 110 may each be controlled by, or provide input to, the microprocessor 50. In addition, the temperature and pressure of the entire liquid chromatography system may be controlled in any desired manner.

Referring now to FIGS. 2A-2E, a method is illustrated for flashing a reservoir fluid sample from reservoir conditions to a given pressure and a given temperature at a controlled rate utilizing a flash system 10 similar to the system described above. In FIG. 2A, the live sample is initially contained in the sample chamber 40, preferably at reservoir conditions, blocked by the course valve 21. The live sample is displaced from the sample chamber 40, in this example by opening the course valve 21, and driving the floating piston 42 with a predetermined amount hydraulic fluid. FIG. 2B shows the live sample traveling through the sample line 45 to be controlled by the metering valve, or fine valve, 23. The sample line 45 leading from the sample chamber 40 enters the bottom of the separating chamber 22 in an alternative arrangement to that shown in FIG. 1. As shown in FIG. 2C, the flashed sample exiting the metering valve 23 preferably enters the separating chamber 22 to enable a good contact between the gas and liquid phase for equilibrium to occur. The gas and liquid level is shown to rise in the separating chamber 22 of FIG. 2D. The gas phase exits through the gas vent line 25 and through the gas flow meter 26 where a signal representative of the gas flow rate can be sent to the microprocessor 50 for automated control of the pump 30, the course valve 21, and the metering valve 23 based on various input parameters, such as sample fluid properties and characteristics, hydraulic fluid characteristics, downstream pressure and temperature, upstream pressure and temperature, and the like. The gas may then be directed to either the gas bag 70 or gas chromatograph 60, as shown in FIG. 2E, for further analysis.

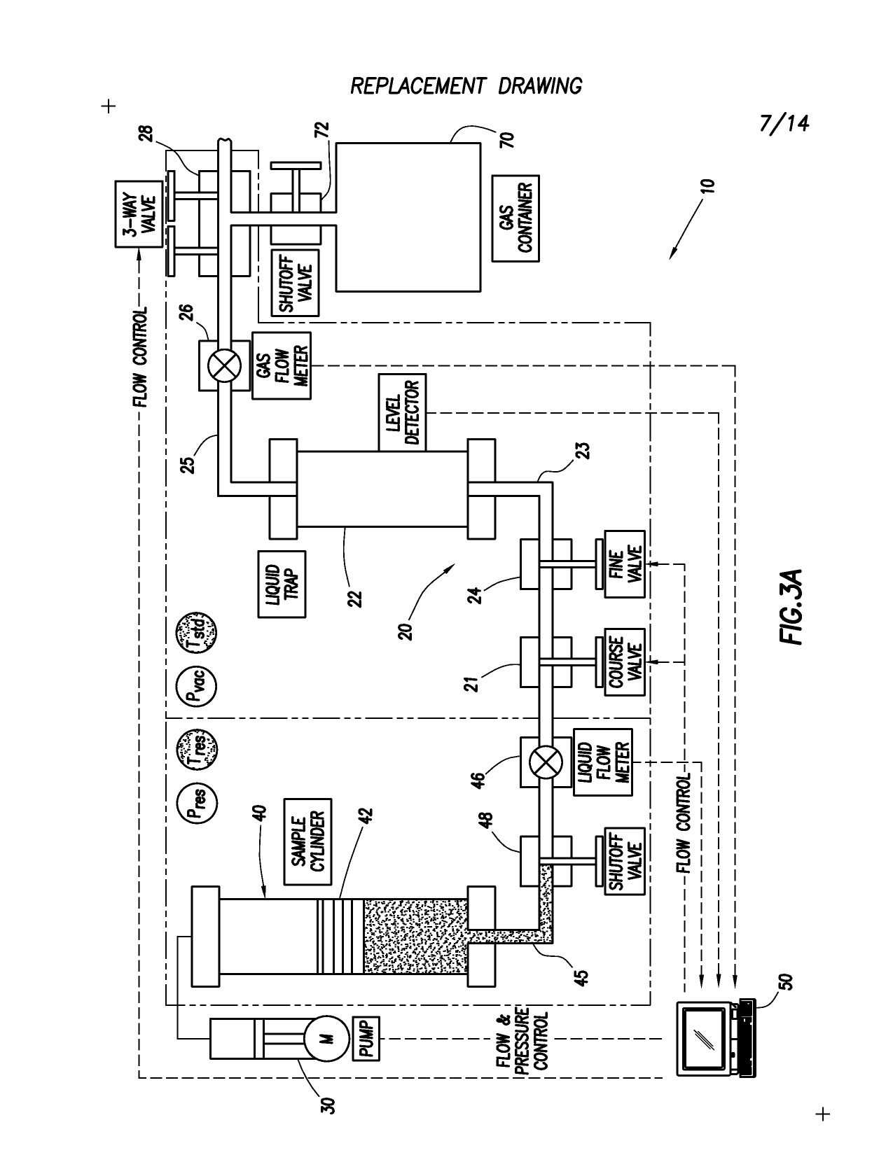

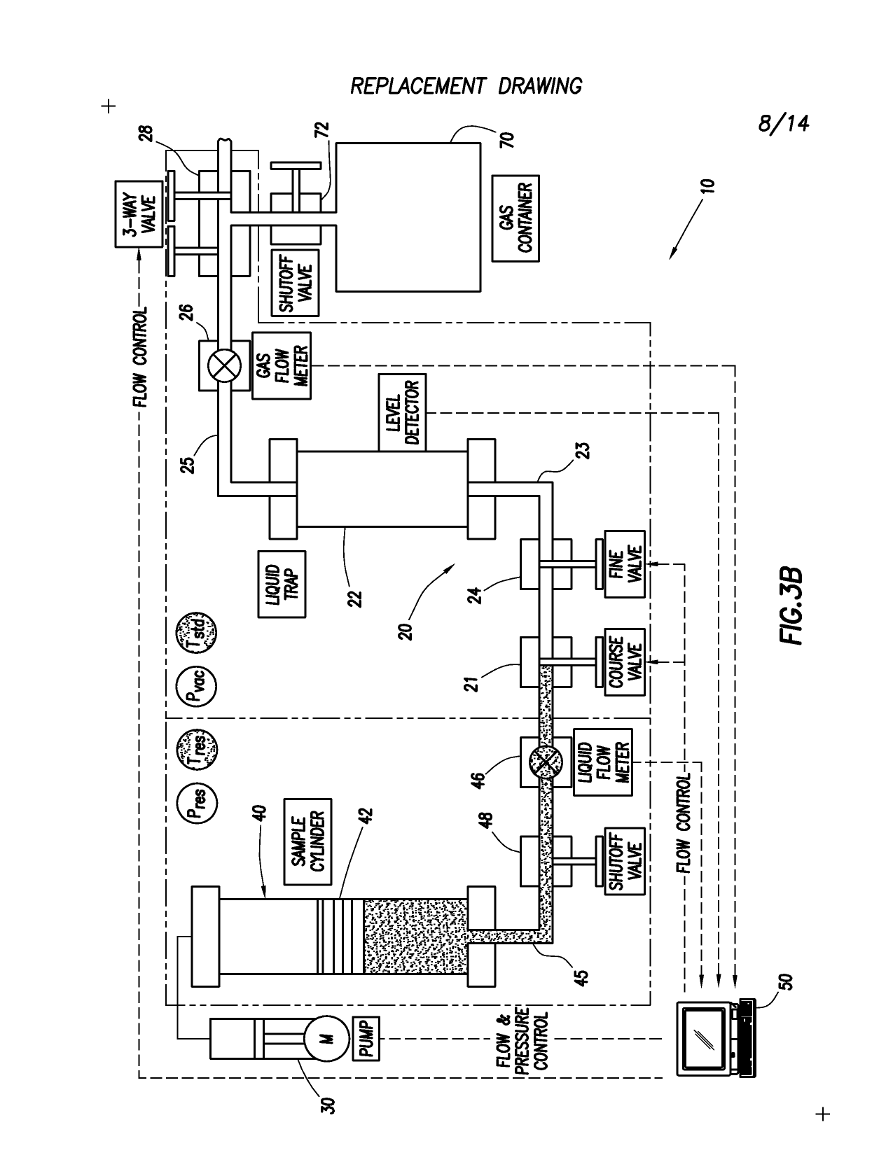

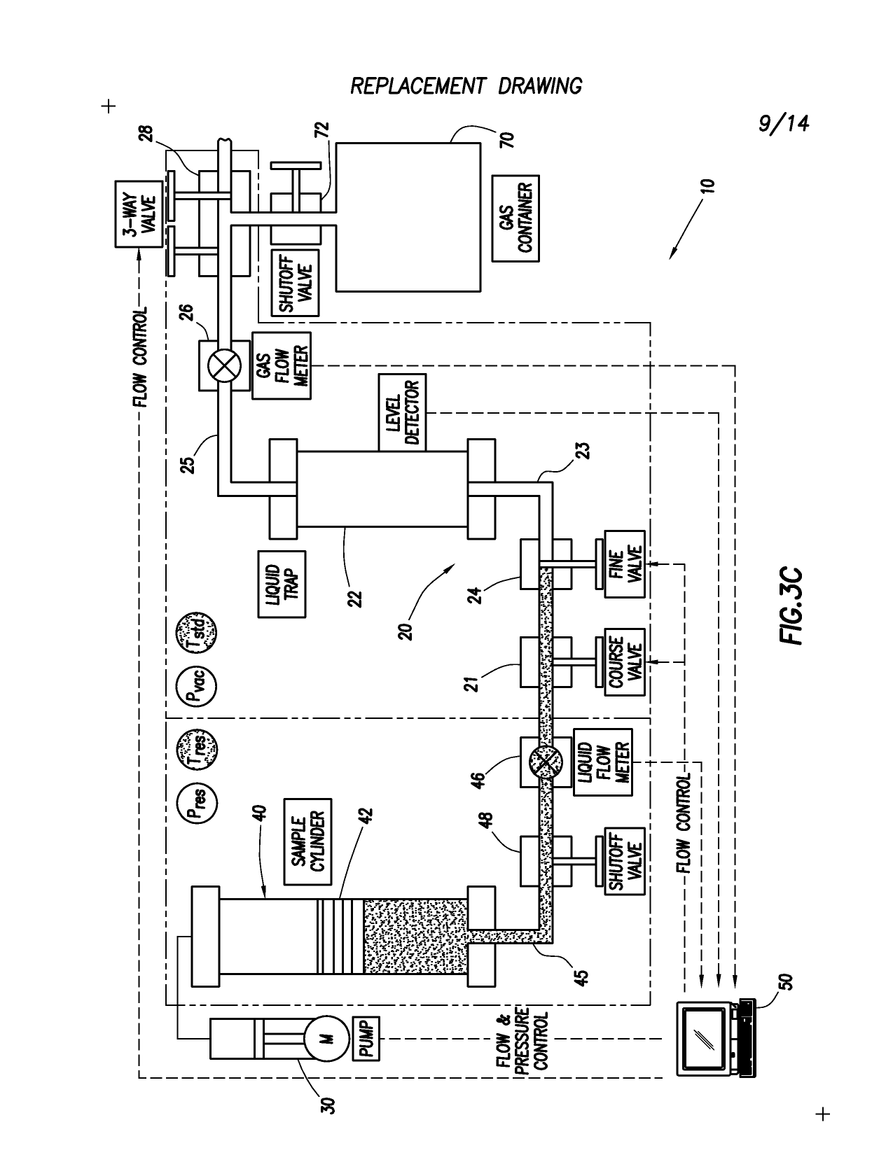

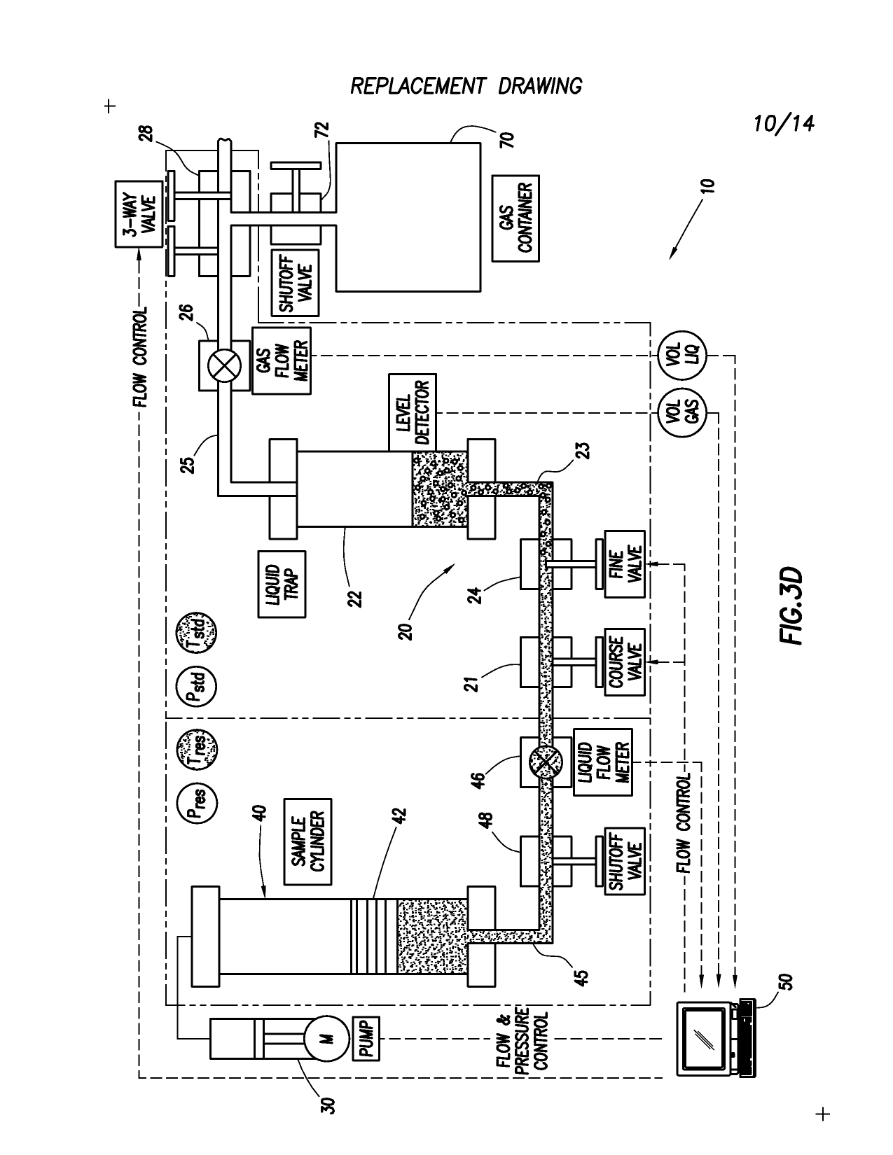

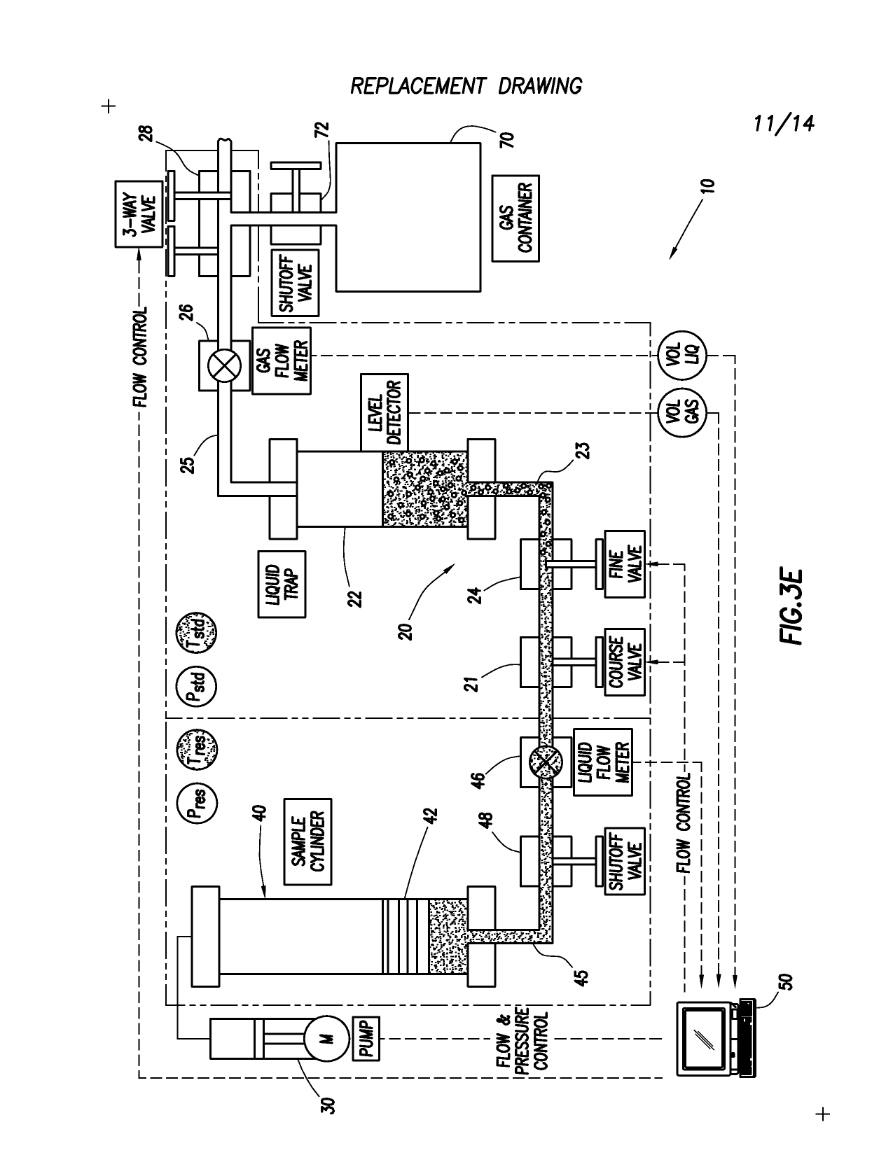

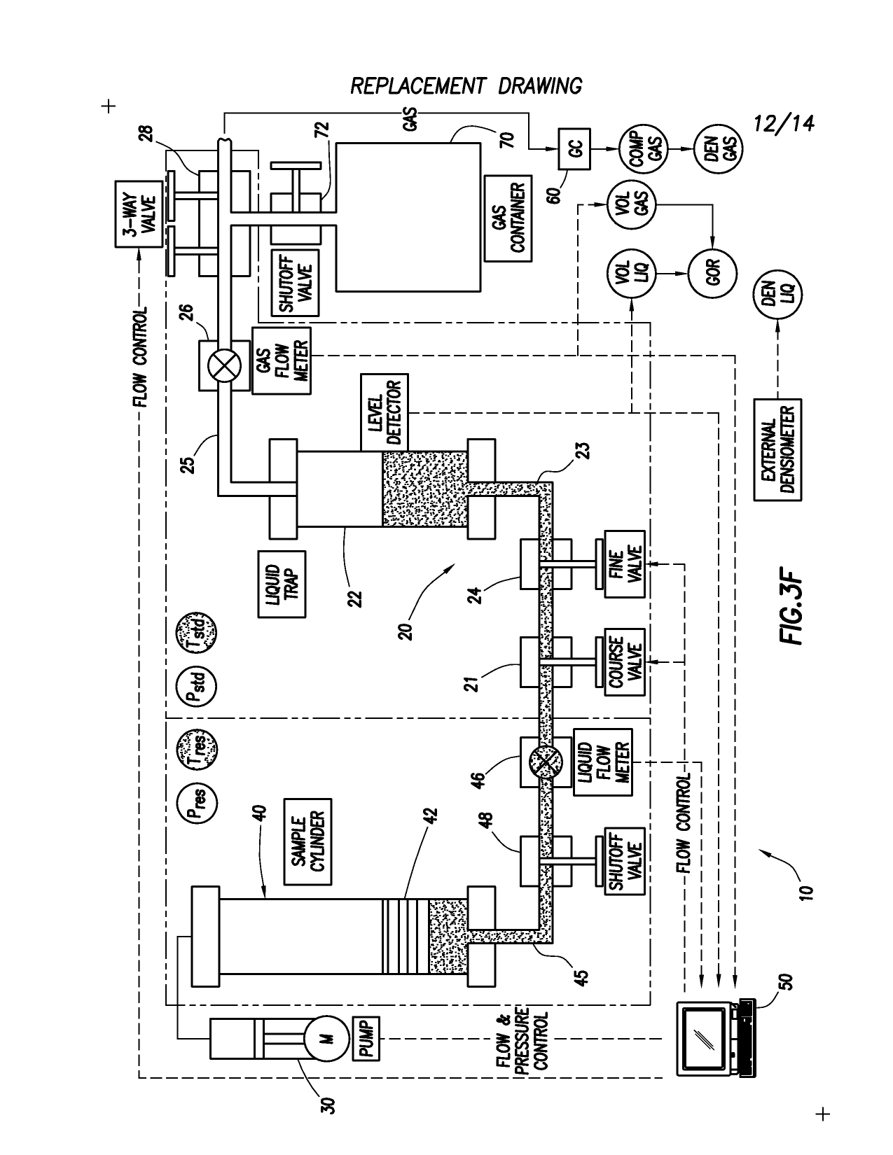

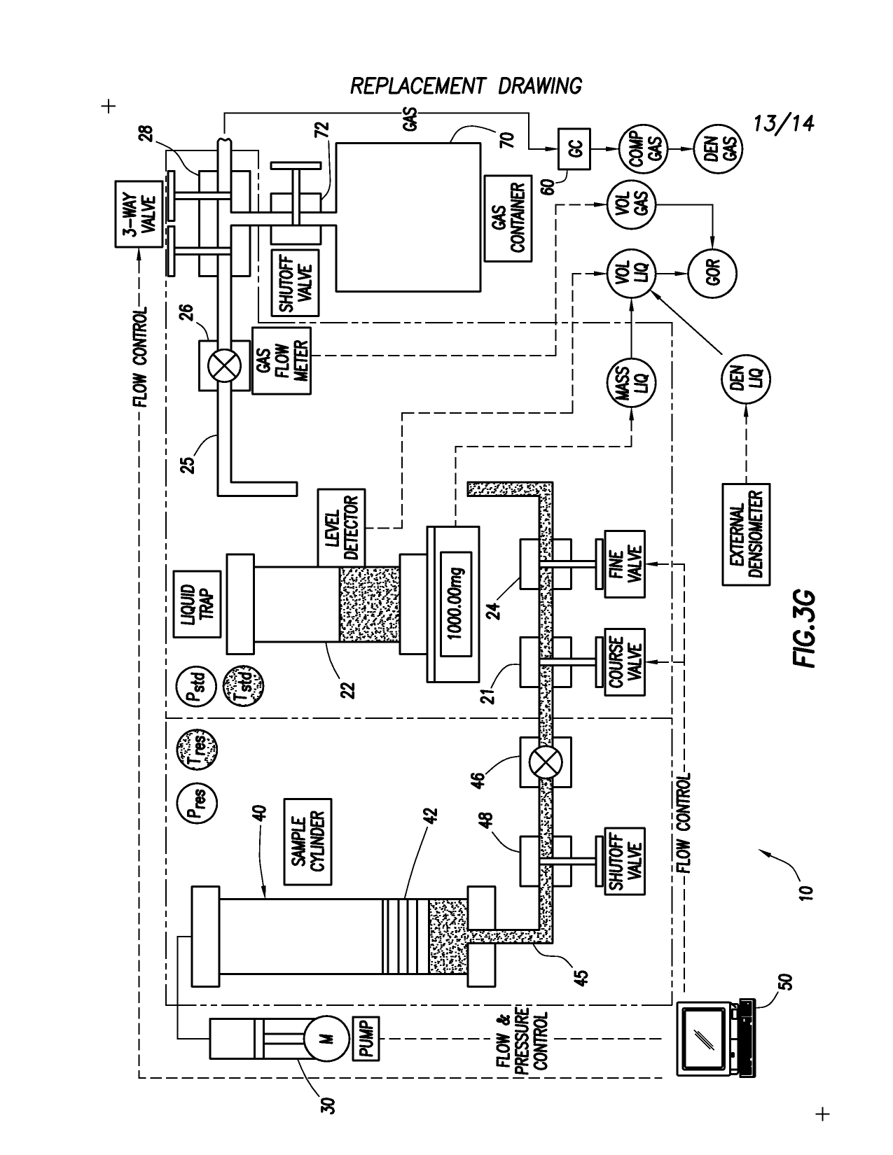

Referring now to FIGS. 3A-3G, an alternative system and method is illustrated for flashing a reservoir fluid sample from reservoir conditions to a given pressure and a given temperature at a controlled rate in a similar manner to that described herein. Shown in FIGS. 3A-3G is a sample chamber 40 in an alternative arrangement to the sample chamber 40 shown in FIGS. 1 and 2A-2E, illustrating that the sample chamber 40 may be in any configuration necessary to provide the live sample to the flash apparatus 20. In fluid communication with the sample line 45 is a shutoff valve 48 for controlling flow of the live sample, and a liquid flow meter 46 for measuring the flow rate of the sample exiting the sample chamber 40. In addition, a course valve 21 may be positioned in the sample line 45 to control the flow of the live sample entering the metering valve 24. However, it may be determined that either a course valve 21 or a shutoff valve 48 are not required, or that the metering valve 24 alone is sufficient to both block the live sample initially contained in the sample chamber 22 and meter, or regulate, the flow and separation of the live sample into separate phases at or around atmospheric conditions. As illustrated in FIG. 3D, the controlled operation of the metering valve 24 flashes the live sample from the downstream reservoir conditions to a lower pressure and temperature (i.e., atmospheric). The flashed sample enters the separating chamber 22 wherein a level detector may be used to determine the volume of the gas and/or liquid in the separating chamber 22. The measured volume may be input into the microprocessor 50 for use in controlling the metering valve 24 and/or the pump 30. Additionally, the rate of gas exiting the separating chamber 22 and measured by the gas flow meter 26 may be input into the microprocessor 50 for use in controlling the metering valve 24 and/or the pump 30. Positioned on the gas vent line 25, a switching valve, or 3-way valve, 28 may be used to direct the gas flow into a gas bag, or gas container, 70 or into a gas chromatograph 60 for further analysis. FIG. 3G shows a further analysis step that may be performed in an exemplary method where the mass and/or volume of the flashed liquid portion is measured. In combination with a measurement of the liquid density, by an external densitometer or the like, and a measurement of the volume of gas exiting the flash apparatus 20, the GOR can be determined.

The system 10 is preferably designed in such a way to ensure quasi-equilibrium of the phases at the set-up conditions. The automation will ensure the repeatability of the process independently of the operator skill. Furthermore, the size of the flash apparatus 20 may be minimized, and the range of measurements may be expanded as compared to conventional systems, and may be optimized to minimize the overall flow path volume.

The universal flash system 10 may be used for applications in wellsite fluid analysis (i.e., PVT or sample validation), laboratory analysis (i.e., PVT, compositional analysis, fluid property studies for enhanced oil recovery, or the like), flow metering applications (multiphase flow measurements), and separator applications. Each component of the flash system 10, described in the embodiments herein, which are exposed to reservoir fluids are preferably constructed from a material chemically inert to natural petroleum fluid components (i.e., hydrocarbons, H₂S, CO₂, heavy metals, and the like).

While the present invention has been described with respect to a limited number of embodiments, those skilled in the art, having benefit of this disclosure, will appreciate that other embodiments can be devised which do not depart from the scope of the present invention as disclosed herein.

What is claimed is:

1. A flash system adapted to control the rate of flashing of a reservoir fluid sample from reservoir conditions to a given pressure and temperature in order to produce a liquid and gas phase of the sample, the flash system comprising:
a flash apparatus including a separating chamber, a metering valve positioned at an inlet of the separating chamber, and a gas flow meter positioned at an outlet of the separating chamber;
a pump adapted to displace the sample from a sample chamber to the flash apparatus; and
means for automatically controlling the metering valve and the pump to control the pump speed and the discharge rate of the metering valve.

2. The system according to claim 1, wherein the metering valve comprises an outlet tube that drives the sample to a bottom of the separating chamber.

3. The system according to claim 1, wherein the gas flow meter measures the flow rate of the gas leaving the separating chamber, and the measured flow rate of the gas is used in controlling the pump speed and the discharge rate of the metering valve.

4. The system according to claim 1, further comprising a gas chromatograph to measure physical properties of the gas exiting the flash apparatus.

5. The system according to claim 1, further comprising a gas bag to store the gas exiting the flash apparatus.

6. The system according to claim 1, wherein the separating chamber comprises a means for measuring the volume of liquid exiting the metering valve.

7. The system according to claim 1, further comprising a liquid chromatograph to measure physical properties of the liquid exiting the metering valve.

8. The system according to claim 1, wherein the means for automatically controlling the metering valve and the pump comprises a microprocessor.

9. The system according to claim 1, wherein the means for automatically controlling the metering valve and the pump comprises a plurality of sensors in a closed-loop control system.

10. The system according to claim 1, further comprising a sample chamber for storing the sample.

11. The system according to claim 10, wherein the sample chamber comprises a floating piston for applying a desired pressure on the sample.

12. The system according to claim 10, further comprising a liquid flow meter positioned near an outlet of the sample chamber for measuring the flow rate of the sample leaving the sample chamber, and the measured flow rate of the sample is used in controlling the pump speed and the discharge rate of the metering valve.

13. The system according to claim 1, wherein the given pressure and given temperature is atmospheric pressure and standard temperature, respectfully.

14. The system according to claim 1, further comprising a liquid storage chamber for safely storing the liquid exiting the metering valve.

15. A method to control the rate of flashing of a reservoir fluid sample from reservoir conditions to a given pressure and temperature in order to produce a liquid and gas phase of the sample, the method comprising the steps of:
displacing the sample from a sample chamber to a flash apparatus using a pump, the flash apparatus comprising a separating chamber, a metering valve positioned at an inlet of the separating chamber, and a gas flow meter positioned at an outlet of the separating chamber; and
flash separating the sample in the separating chamber to generate a gas and a liquid phase, wherein the metering valve and the pump are controlled by a microprocessor to ensure control of the flashing rate through direct control of the pump speed and discharge rate of the metering valve.

16. The method according to claim 15, comprising the step of analyzing the separated gas and liquid phase using a gas chromatograph or liquid chromatograph, respectfully.

17. The method according to claim 15, further comprising the step of measuring the mass of the liquid in the separating chamber.

18. The method according to claim 15, further comprising the step of measuring the density and viscosity of the liquid in the separating chamber.
